(19) United States
(12) Patent Application Publication
(10) Pub. No.: US 2007/0296934 A1
(43) Pub. Date: Dec. 27, 2007

(54) Image Forming Apparatus and Method of Controlling the Apparatus

(75) Inventor: Kazunori Hirabayashi, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/423,397

(22) Filed: Jun. 9, 2006

(51) Int. Cl. G03B 27/00

(52) U.S. Cl. 355/18

(57) ABSTRACT

PDL data in a storage area on a network is stored into a hard disk drive 13 of an MFP 1 in the form in which it is converted into image data. The image data in the hard disk drive 13 can be printed at any time, any number of times and repeatedly.

### BACKGROUND OF THE INVENTION

A composite image forming apparatus (called an MFP) having plural functions such as a copy function, a scan function and a print function can print image data inputted from a network-connected medium, for example, a personal computer.

The image data inputted from the personal computer is PDL (Page Description Language) data which a printer (printer engine) of the MFP can understand. The PDL data is inputted from the personal computer to the MFP in accordance with a user's print instruction.

The MFP uses a built-in RIP (Raster Image Processor) to analyze the PDL data inputted from the personal computer and performs rasterization (also called rendering processing) based on a previously set print condition. By this, the PDL data is converted into bitmap format image data which the printer can understand. The print condition is set by the user and by one of the personal computer and the MFP.

From the creation of the PDL data by the personal computer to the completion of the print of the MFP, there exist the operation of setting of the print condition, the operation of the print instruction, the rasterization by the RIP, and the like.

A time required for the rasterization varies according to the PDL data. According to the PDL data, it takes a lot of time to perform the rasterization. In this case, the time that elapses before printing is completed becomes long, and it is inconvenient for the user.

### BRIEF SUMMARY OF THE INVENTION

An object of an embodiment of the invention is to provide an image forming apparatus which can greatly shorten the time that elapses before printing is completed.

An image forming apparatus of an embodiment of the invention is connected to a network having at least one storage area and has at least a print function, and includes

a retrieval section configured to retrieve new data in the storage area,

a memory section,

a first control section configured to transfer, in a case where the new data retrieved by the retrieval section is analyzable PDL data, the PDL data to the memory section and to store it,

a processing section configured to convert the PDL data in the memory section into image data by rasterization based on a previously determined print condition,

a second control section configured to store the image data converted by the processing section into the memory section, and

a third control section configured to print the image data in the memory section by the print function when a print instruction is issued.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram of a control circuit of each of embodiments.

FIG. 2 is a flowchart for explaining the operation of a first embodiment.

FIG. 3 is a flowchart for explaining the operation of a second embodiment.

FIG. 4 is a flowchart for explaining the operation of a third embodiment.

FIG. 5 is a flowchart for explaining the operation of a fourth embodiment.

FIG. 6 is a flowchart for explaining the operation of a fifth embodiment.

### DETAILED DESCRIPTION OF THE INVENTION

[1] Hereinafter, a first embodiment of the invention will be described with reference to the drawings.

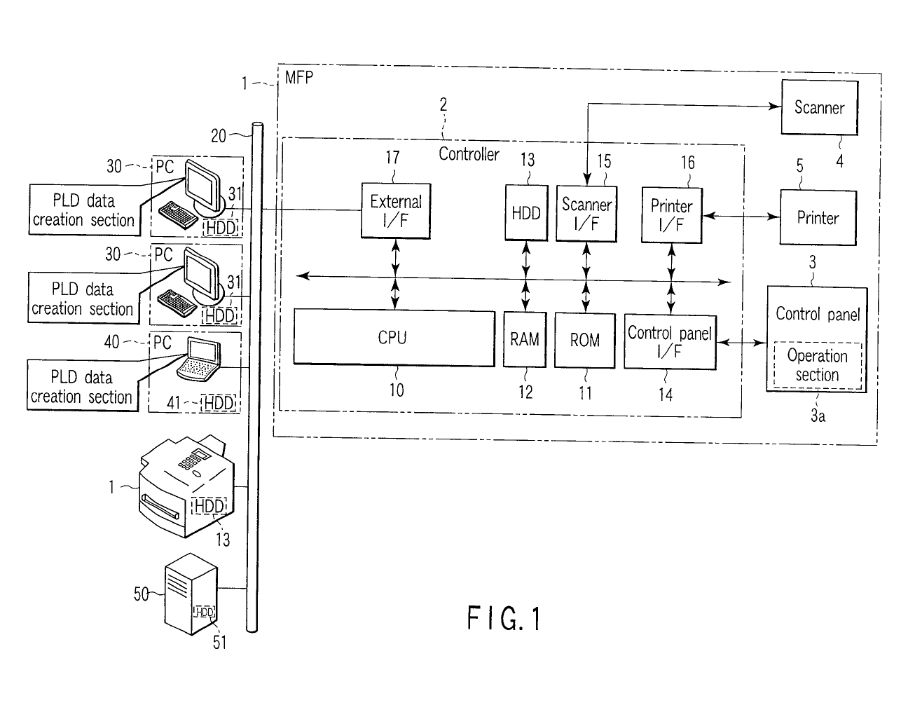

In FIG. 1, reference numeral 1 denotes a composite image forming apparatus, a so-called MFP, having plural functions such as a copy function, a scan function and a print function. The MFP 1 includes a controller 2, a control panel 3, a scanner 4, and a printer (also called a printer engine) 5.

The controller 2 includes a CPU 10 as a main control part, a ROM 11 for program storage, a RAM 12 as a memory section for data storage, a hard disk drive (HDD) 13 as a large capacity memory section, a control panel interface (I/F) 14, a scanner interface (I/F) 15, a printer interface (I/F) 16, and an external interface (I/F) 17.

A program of an RIP (Raster Image Processor) is stored in one of the ROM 11 and the hard disk drive 13, and the program is loaded into the RAM 11 at the time of start of the MFP 1 and is executed by the CPU 10. That is, an RIP processing is executed.

The control panel 3 includes an operation section 3a for setting print conditions (the number of prints, the presence/absence of a staple, a print mode, etc.).

The scanner 4 optically reads an image of a document set on the MFP 1. Image data read by the scanner 4 or PDL (Page Description Language) data as image data created by an external personal computer 30 and inputted to the MFP 1 is converted into bitmap format image data by the RIP. The printer 5 prints color images respectively corresponding to the image data Y, M, C and K onto a print sheet.

Plural media, for example, a desktop personal computer 30, a notebook personal computer 40, another MFP 1, and a server 50 are connected to an external interface 17 through a network cable 20. The notebook personal computer 40 is freely connected to and separated from the network cable 20. Each of memory sections, such as a hard disk drive 31 of the personal computer 30, a hard disk drive 41 of the personal computer 40, a hard disk drive 13 of the other MFP 1, and a hard disk drive 51 of the server 50, functions as a storage area on the network.

Each of the personal computers 30 and 40 includes a PDL data creation section to create PDL data by various built-in application programs (word processor, table calculation, presentation, DTP software, etc.). The created PDL data is stored in one of the hard disk drives 31 and 41 of the respective personal computers and the hard disk drive 51 of the server 50.

The CPU 10 has following sections (1) to (5) as main functions.

(1) A retrieval section that retrieves new data in the respective storage areas on the network.

(2) A first control section that transfers, in a case where the new data retrieved by the retrieval section is analyzable PDL data, the PDL data from the storage area to the hard disk drive 13 and stores it.

(3) A processing section (RIP) that converts the PDL data in the hard disk drive 13 into image data by rasterization based on a previously determined print condition.

(4) A second control section that stores the image data converted by the processing section into the hard disk drive 13.

(5) A third control section that prints the image data in the hard disk drive 13 by a print function when a print instruction based on the user's operation of the control panel 3 is issued or when a print instruction is issued from the personal computer 30, 40.

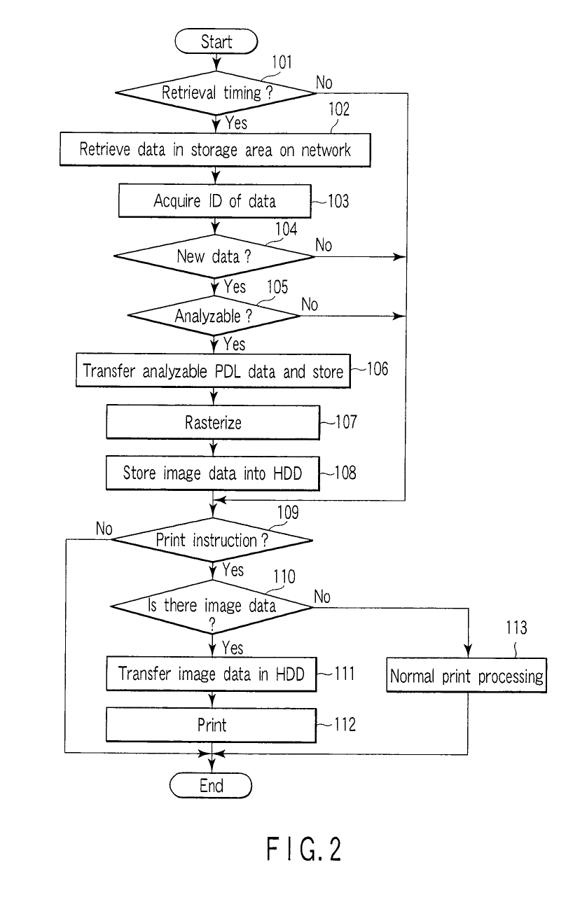

Next, the operation will be described with reference to a flowchart of FIG. 2.

At a periodic retrieval timing (at intervals of a constant time) (YES at step 101), data in the respective storage areas on the network is retrieved (step 102). In the case where the data is found, an ID (for example, a file name, a format, a creation time, an update time, etc.) of the data is acquired by the MFP 1 (step 103). The acquired ID is stored in the RAM 12. Then, it is judged based on the ID in the RAM 12 whether the retrieved data is new data (step 104).

In this case, the storage area as the object of the retrieval may be one of or more than one of the hard disk drive 31 of the personal computer 30, the hard disk drive 41 of the personal computer 40, the hard disk drive 13 of the other MFP 1, and the hard disk drive 51 of the server 50.

When the retrieved data is the new data (including updated data) (YES at step 104), it is judged whether the new data is analyzable PDL data (step 105). When it is the analyzable PDL, data (YES at step 105), the PDL data is transferred from the storage area to the hard disk drive 13 and is stored (step 106).

The PDL data stored in the hard disk drive 13 is rasterized (also called rendering processing) by the RIP based on a previously determined print condition (step 107). By this, the PDL data in the hard disk drive 13 is converted into bitmap format image data which the printer can understand. The converted image data is stored in the hard disk drive 13 (step 108).

When a print instruction is issued (YES at step 109), it is judged whether image data corresponding to identification data inputted together with the print instruction is stored in the hard disk drive 13 (step 110). When the image data corresponding to the identification data is stored in the hard disk drive 13 (YES at step 110), the image data is read from the hard disk drive 13 and is transferred to the printer 5 (step 111). The printer 5 prints an image corresponding to the image data onto a print sheet (step 112).

After that, each time a print instruction is received, one of or more than one of image data in the hard disk drive 13 are immediately printed without requiring rasterization. Since the rasterization is unnecessary, the time that elapses before printing is completed can be greatly shortened. Thus, the waiting time of the user runs out and it is convenient.

Besides, when the print instruction is issued (YES at step 109), and when the image data corresponding to the identification data is not stored in the hard disk drive 13 (NO at step 110), a normal print processing is executed (step 113).

In the normal print processing, PDL data and a print condition transferred from one of the personal computers 30 40 and the other MFP 1 are captured, and the captured PDL data is rasterized by the RIP based on the captured print condition. Image data obtained by this rasterization is transferred to the printer 5. The printer 5 prints an image corresponding to the image data onto a print sheet.

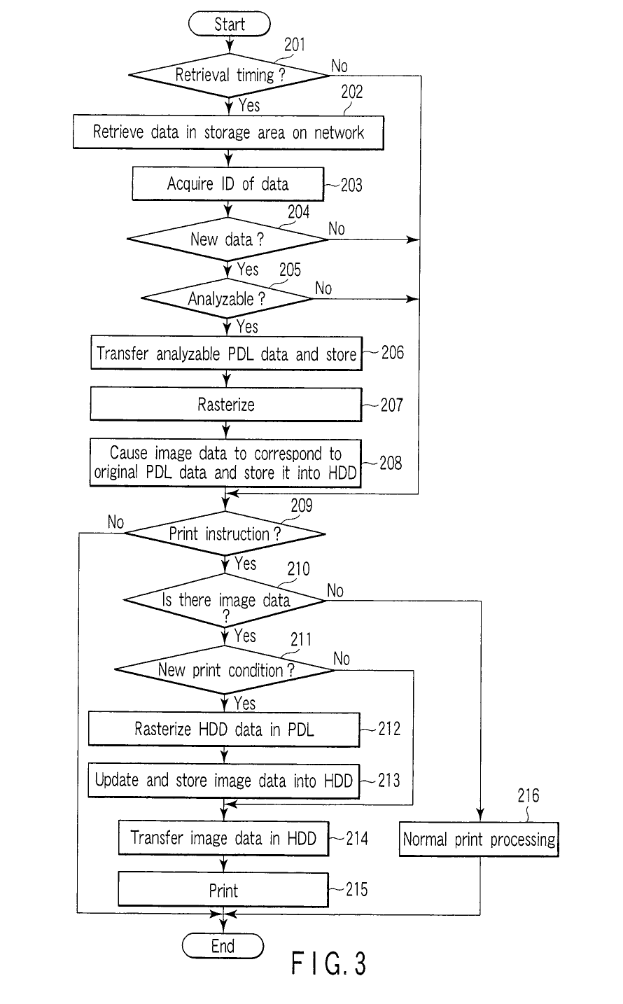

As stated above, the PDL data in the storage area on the network can be stored in the hard disk drive 13 of the MFP 1 in the form in which it is converted into the image data. Accordingly, even in the case where the storage area on the network becomes unconnectable to the network, the image data corresponding to the PDL data in the storage area on the network can be printed at any time, any number of times and repeatedly.

[2] A second embodiment will be described with reference to a flowchart of FIG. 3.

At a periodic retrieval timing (YES at step 201), data in the respective storage areas on the network is retrieved (step 202). In the case where the data is found, an ID (for example, a file name, a format, a creation time, an update time, etc.) of the data is acquired by the MFP 1 (step 203). The acquired ID is stored in the RAM 12. Then, it is judged based on the ID in the RAM 12 whether the retrieved data is new data (step 204).

When the retrieved data is the new data (including updated data) (YES at step 204), it is judged whether the new data is analyzable PDL data (step 205). When it is the analyzable PDL data (YES at step 205), the PDL data is transferred from the storage area to the hard disk drive 13 and is stored (step 206).

The PDL data stored in the hard disk drive 13 is rasterized by the RIP based on a previously determined print condition (step 207). By this, the PDL data in the hard disk drive 13 is converted into bitmap format image data which the printer can understand. The converted image data is made to correspond to the original PDL data before the conversion, and is stored in the hard disk drive 13 (step 208).

When a print instruction is issued (YES at step 209), it is judged whether image data corresponding to identification data inputted together with the print instruction is stored in the hard disk drive 13 (step 210). When the image data corresponding to the identification data is stored in the hard disk drive 13 (YES at step 210), and a new print condition different from the print condition is not set (NO at step 211), the image data corresponding to the identification data is read from the hard disk drive 13 and is transferred to the printer 5 (step 214). The printer 5 prints an image corresponding to the image data onto a print sheet (step 215).

After that, each time a print instruction is received, one of or more than one of image data in the hard disk drive 13 are immediately printed without requiring rasterization. Since the rasterization is unnecessary, the time that elapses before printing is completed can be greatly shortened. Thus, the waiting time of the user runs out and it is convenient.

Incidentally, in the case where the new print condition is set (YES at step 211), the original PDL data, which is made to correspond to the image data corresponding to the identification data and is stored, is rasterized based on the new print condition (step 212). By this, the original PDL data in the hard disk drive 13 is converted into bitmap format image data which the printer can understand. The converted image data is updated and stored in the hard disk drive 13 (step 213), and is transferred to the printer 5 (step 214). The printer 5 prints an image corresponding to the image data onto a print sheet (step 215).

Besides, when the print instruction is issued (YES at step 209), and when the image data corresponding to the identification data is not stored in the hard disk drive 13 (NO at step 210), a normal print processing is executed (step 216).

In the normal print processing, PDL data and a print condition transferred from one of the personal computers 30 40 and the other MFP 1 are captured, and the captured PDL data is rasterized by the RIP based on the captured print condition. Image data obtained by the rasterization is transferred to the printer 5. The printer 5 prints an image corresponding to the image data onto a print sheet.

As stated above, the PDL data in the storage area on the network can be stored in the hard disk drive 13 of the MFP 1 in the form in which it is converted into the image data and in the form of the original before the conversion. In the case where a print condition is newly set, new image data can be obtained using the original PDL data in the hard disk drive 13. Accordingly, even in the case where the storage area on the network becomes unconnectable to the network, the image data corresponding to the PDL data in the storage area on the network can be printed at any time, any number of times and repeatedly.

Even in the case where a trouble occurs in the storage area on the network, and the original PDL data disappears, since the same PDL data is stored in the hard disk drive 13 of the MFP 1, safety is assured.

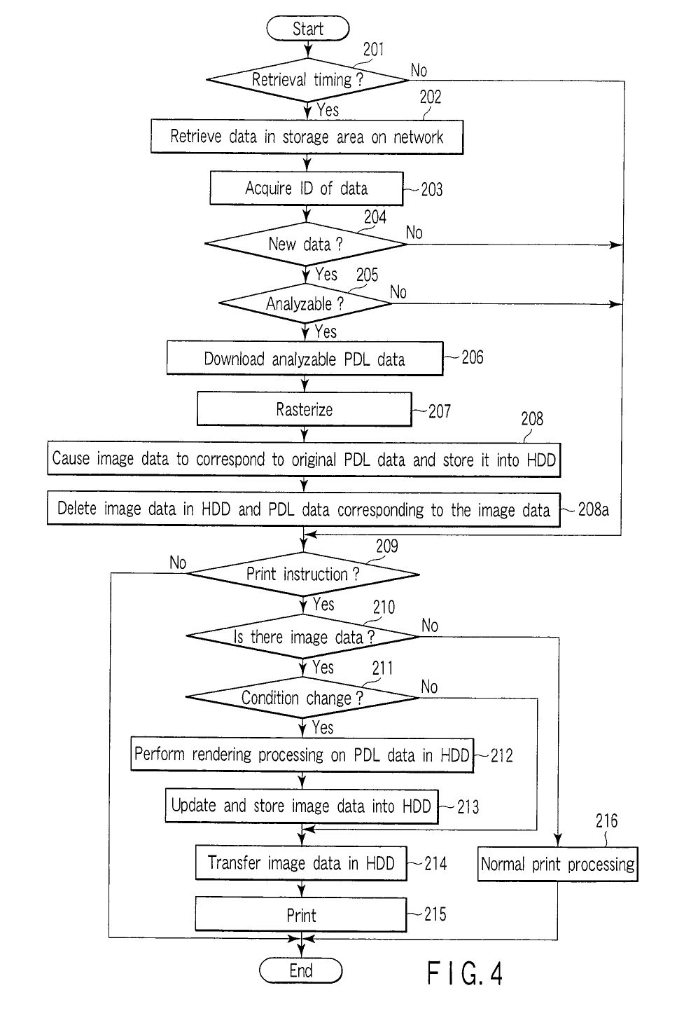

The other structure and operation are the same as those of the first embodiment. Thus, their description will be omitted.

[3] A third embodiment will be described with reference to a flowchart of FIG. 4.

A processing of step 208a is added between the processing of the step 208 and the processing of the step 209 of the second embodiment.

At step 208, image data obtained by rasterization is made to correspond to original PDL data, and is stored in the hard disk drive 13. With this storage, at least one old image data in the hard disk drive 13 and the PDL data corresponding to the image data are deleted (step 208a).

In this way, temporally new image data and PDL data are preferentially stored in the hard disk drive 13. Accordingly, the limited storage capacity of the hard disk drive 13 can be efficiently used.

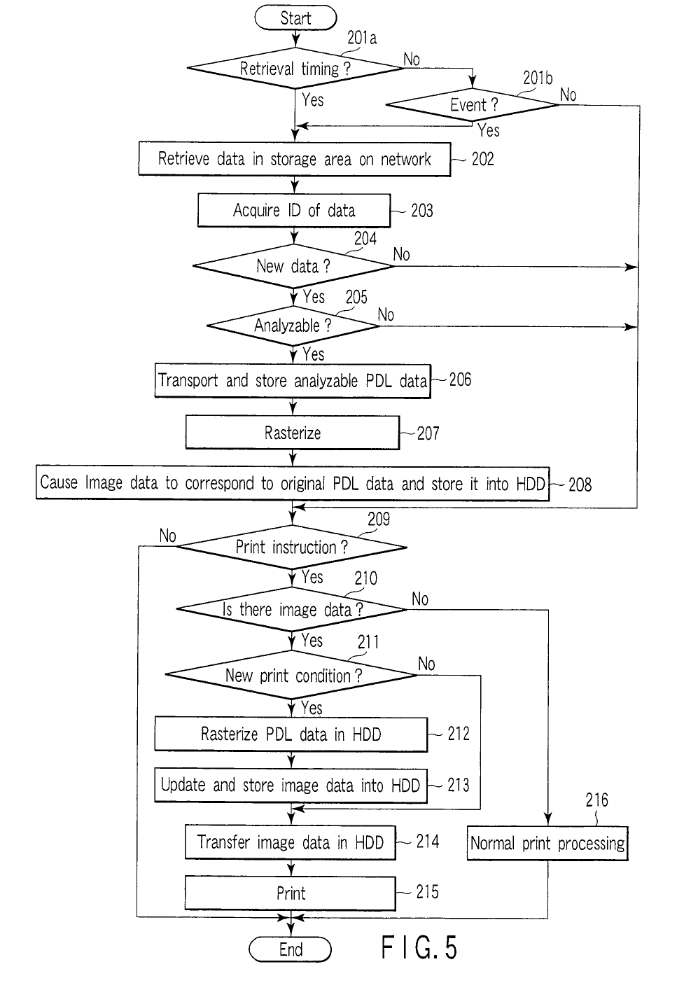

The other structure, operation and effect are the same as those of the second embodiment. Thus, their description will be omitted.

[4] A fourth embodiment will be described with reference to a flowchart of FIG. 5.

Steps 201a 201b are adopted instead of the step 201 of the second embodiment.

That is, at a periodic retrieval timing (YES at step 201a) or at a time of occurrence of a previously determined event (YES at step 201b), data in the respective storage areas on the network is retrieved (step 202).

The event means, for example, the connection of the notebook personal computer 40 to the network cable 20. That the personal computer 40 is connected to the network cable 20 means that new PDL data is added onto the network.

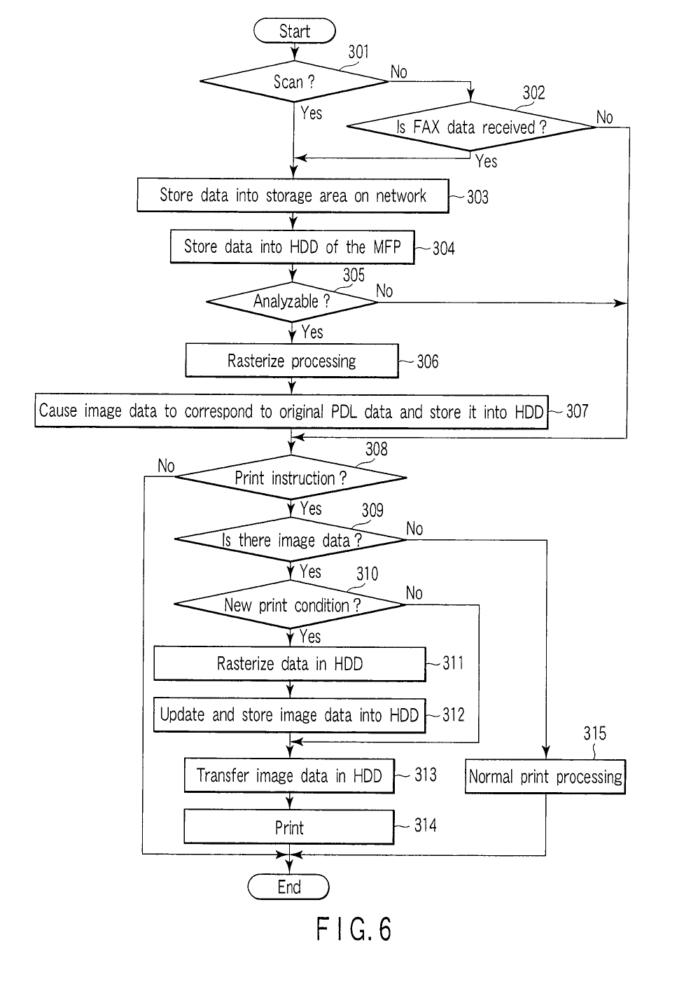

The other structure, operation and effect are the same as those of the second embodiment. Thus, their description will be omitted.

[5] A fifth embodiment will be described with reference to a flowchart of FIG. 6.

The CPU 10 has following sections (11) to (14) as main functions.

(11) A first control section that stores data obtained by one of a scan function and a facsimile function into a storage area on a network, and stores it into the hard disk drive 13.

(12) A processing section (RIP) that converts, in a case where the data in the hard disk drive 13 is analyzable PDL data, the PDL data into image data by rasterization based on a previously determined print condition.

(13) A second control section that stores the image data converted by the processing section into the hard disk drive 13.

(14) A third control section that prints the image data in the hard disk drive 13 by the print function when a print instruction based on the user's operation of the control panel 3 is issued, or when a print instruction is issued from the personal computer 30, 40.

Next, the operation will be described with reference to a flowchart of FIG. 6.

In the case where an image of a document is scanned in the MFP 1 (YES at step 301), or in the case where data faxed from an equipment on the network is received by the MFP 1 (YES at step 302), the data obtained by the scan or the data obtained by the FAX reception is stored in the storage area on the network, for example, the hard disk drive 51 of the server 50 (step 303), and is stored in the hard disk drive 13 of the MFP 1 (step 304).

Then, it is judged whether the data in the hard disk drive 13 is analyzable PDL data (step 305). When it is the analyzable PDL data (YES at step 305), the PDL data is rasterized by the RIP based on a previously determined print condition (step 306). By this, the PDL data in the hard disk drive 13 is converted into bitmap format image data which the printer can understand. The converted image data is made to correspond to the original PDL data before the conversion, and is stored in the hard disk drive 13 (step 307).

When a print instruction is issued (YES at step 308), it is judged whether image data corresponding to identification data inputted together with the print instruction is stored in the hard disk drive 13 (step 309). When the image data corresponding to the identification data is stored in the hard disk drive 13 (YES at step 309) and a new print condition different from the print condition is not set (NO at step 310), the image data corresponding to the identification data is read from the hard disk drive 13 and is transferred to the printer 5 (step 313). The printer 5 prints an image corresponding to the image data onto a print sheet (step 314).

After that, each time a print instruction is received, one of or more than one of image data in the hard disk drive 13 are immediately printed without requiring rasterization. Since the rasterization is unnecessary, the time that elapses before printing is completed can be greatly shortened. Thus, the waiting time of the user runs out and it is convenient.

In the case where the new print condition is set (YES at step 310), the original PDL data, which is made to correspond to the image data corresponding to the identification data and is stored, is rasterized based on the new print condition (step 311). By this, the original PDL data in the hard disk drive 13 is converted into bitmap format image data which the printer can understand. The converted image data is updated and stored in the hard disk drive 13 (step 312), and is transferred to the printer 5 (step 313). The printer 5 prints an image corresponding to the image data onto a print sheet (step 314).

Besides, when a print instruction is issued (YES at step 308), and when the image data corresponding to the identification data is not stored in the hard disk drive 13 (NO at step 309), a normal print processing is executed (step 315).

In the normal print processing, PDL data obtained by scanning, or PDL data obtained by FAX reception is rasterized by the RIP based on the print condition set by the user. The image data obtained by the rasterization is transferred to the printer 5. The printer 5 prints an image corresponding to the image data onto a print sheet.

As stated above, the PDL data obtained by scanning or the PDL data obtained by FAX reception can be stored in the hard disk drive 13 of the MFP 1 in the form in which it is converted into the image data and in the form of the original before the conversion. In the case where a print condition is newly set, new image data can be obtained using the original PDL data in the hard disk drive 13.

Even in the case where the original. PDL data in the hard disk drive 13 disappears by some cause, since the same PDL data is stored in the storage area on the network, safety is assured.

Incidentally, although the hard disk drive 51 of the server 50 is used as the storage destination of the data obtained by scanning or the data obtained by FAX reception, no limitation is made to the server 50, and one of or more than one of the hard disk drive 31 of the personal computer 30, the hard disk drive 41 of the personal computer 40, and the hard disk drive 13 of the other MFP 1 may be used.

The other structure and operation are the same as those of the first embodiment. Thus, their description will be omitted.

Additional advantages and modifications will readily occur to those skilled in the art. Therefore, the invention in its broader aspects is not limited to the specific details and representative embodiments shown and described herein. Accordingly various modifications may be made without departing from the spirit or scope of the general inventive concept as defined by the appended claims and their equivalents.

What is claimed is:

1. An image forming apparatus which is connected to a network having at least one storage area and has at least a print function, comprising:
a retrieval section configured to retrieve new data in the storage area;
a memory section;
a first control section configured to transfer, in a case where the new data retrieved by the retrieval section is analyzable PDL data, the PDL data from the storage area to the memory section and to store it;
a processing section configured to convert the PDL data in the memory section into image data by rasterization based on a previously determined print condition;
a second control section configured to store the image data converted by the processing section into the memory section; and
a third control section configured to print the image data in the memory section by the print function when a print instruction is issued.

2. The apparatus according to claim 1, wherein the storage area is a memory section of one or more media connected to the network.

3. The apparatus according to claim 2, wherein the media are another one or more image forming apparatuses, one or more personal computers, or one or more servers.

4. The apparatus according to claim 1, wherein the retrieval section periodically performs retrieval of the new data in the storage area.

5. The apparatus according to claim 1, wherein the retrieval section performs retrieval of the new data in the storage area periodically and at a time of occurrence of a previously determined event.

6. The apparatus according to claim 5, wherein the storage area is a memory section of one or more media freely connected to and separated from the network, and
the event is connection of the media to the network.

7. The apparatus according to claim 1, wherein
the first control section acquires an ID of the new data retrieved by the retrieval section from the storage area, judges, based on the acquired ID, whether the retrieved new data is the analyzable PDL data, transfers, in a case where a judgment result is affirmative, the PDL data from the storage area to the memory section and stores it.

8. The apparatus according to claim 1, wherein
the second control section causes the image data converted by the processing section to correspond to the analyzable PDL data and stores it into the memory section,
the third control section prints the image data in the memory section by the print function when the print instruction is issued, and when the image data is stored in the memory section and a new print condition different from the print condition is not set, and
when the print instruction is issued, and when the image data is stored in the memory section and the new print condition different from the print condition is set, the third control section converts the PDL data, which is made to correspond to the image data and is stored, into image data by rasterization based on the new print condition, updates and stores the converted image data into the memory section, and prints it by the print function.

9. The apparatus according to claim 8, wherein
the second control section causes the image data converted by the processing section to correspond to the analyzable PDL data and stores it into the memory section, and with this storage, the second control section deletes at least one old image data in the memory section and the PDL data corresponding to the image data.

10. An image forming apparatus which is connected to a network having at least one storage area and has at least a print function, comprising:
retrieval means for retrieving new data in the storage area;
memory means;
first control means for transferring, in a case where the new data retrieved by the retrieval means is analyzable PDL data, the PDL data from the storage area to the memory means and storing it;
processing means for converting the PDL data in the memory means into image data by rasterization based on a previously determined print condition;
second control means for storing the image data converted by the processing means into the memory means; and
third control means for printing the image data in the memory means by the print function when a print instruction is issued.

11. The apparatus according to claim 10, wherein the storage area is memory means of one or more media connected to the network.

12. The apparatus according to claim 11, wherein the media are another one or more image forming apparatuses, one or more personal computers, or one or more servers.

13. The apparatus according to claim 10, wherein the retrieval means periodically performs retrieval of the new data in the storage area.

14. The apparatus according to claim 10, wherein the retrieval means performs retrieval of the new data in the storage area periodically and at a time of occurrence of a previously determined event.

15. The apparatus according to claim 14, wherein the storage area is memory means of one or more media freely connected to and separated from the network, and
the event is connection of the media to the network.

16. The apparatus according to claim 10, wherein
the first control means acquires an ID of the new data retrieved by the retrieval means from the storage means, judges, based on the acquired ID, whether the retrieved new data is the analyzable PDL data, transfers, in a case where a judgment result is affirmative, the PDL data from the storage area to the memory means and stores it.

17. The apparatus according to claim 10, wherein
the second control means causes the image data converted by the processing means to correspond to the analyzable PDL data and stores it into the memory means,
the third control means prints the image data in the memory means by the print function when the print instruction is issued, and when the image data is stored into the memory means and a new print condition different from the print condition is not set, and
when the print instruction is issued, and when the image data is stored in the memory means and the new print condition different from the print condition is set, the third control section converts the PDL data, which is made to correspond to the image data and is stored, into image data by rasterization based on the new print condition, updates and stores the converted image data into the memory means, and prints it by the print function.

18. The apparatus according to claim 17, wherein
the second control section causes the image data converted by the processing means to correspond to the analyzable PDL data and stores it into the memory section, and with this storage, the second control section deletes at least one old image data in the memory means and the PDL data corresponding to the image data.

19. A control method of an image forming apparatus which is connected to a network having at least one storage area and has at least a print function, comprising:
retrieving new data in the storage area;
transferring, in a case where the retrieved new data is analyzable PDL data, the PDL data from the storage area to the memory means and storing it;
converting the PDL data in the memory means into image data by rasterization based on a previously determined print condition;
storing the converted image data into the memory means; and
printing the image data in the memory means by the print function when a print instruction is issued.

20. An image forming apparatus which is connected to a network having at least one storage area and has a scan function, a facsimile function and a print function, comprising:
a memory section;
a first control section configured to store data obtained by one of the scan function and the facsimile function into the storage area and to store it into the memory section;
a processing section configured to convert, in a case where the data in the memory section is analyzable PDL data, the PDL data into image data by rasterization based on a previously determined print condition;
a second control section configured to store the image data converted by the processing section into the memory section; and
a third control section configured to print the image data in the memory section by the print function when a print instruction is issued.
